(19) United States
(12) Patent Application Publication
(10) Pub. No.: US 2021/0276473 A1
(43) Pub. Date: Sep. 9, 2021

(54) EXTENDABLE HIDDEN TRUCK RAMP

(71) Applicant: John Carter, Little Rock, AR (US)

(72) Inventor: John Carter, Little Rock, AR (US)

(21) Appl. No.: 16/813,443

(22) Filed: Mar. 9, 2020

(51) Int. Cl. B60P 1/43; B62D 33/027

(52) U.S. Cl. CPC B60P 1/433; B62D 33/0273

(57) ABSTRACT

An extendable truck bed ramp is housed adjacent the bed of the truck and tailgate when the tailgate is lowered and open. The ramp deploys using a track system inside the bed of the truck and the tailgate respectively. The ramp contains side rails for easy access with items such as hand trucks, ATVs (All Terrain Vehicles), and other wheeled items. The method for joining a truck bed with a loading surface includes attaching at least two parallel tracks to a floor of a truck bed and to a floor side of a tailgate to form continuous tracks based on a foldout of the tailgate, permanently embedding into the at least two parallel tracks each, at least two complementary sliders and moving the truck ramp with folding side rails into a joining position between the truck bed and the loading surface via the at least four sliders attached there beneath.

### BACKGROUND OF THE INVENTION

### Field of Invention

The present invention relates to truck bed ramps of one or multiple pieces that hook onto or over the tailgate of the truck.

### Description of Related Art

GMC, Ford, Toyota, the big three, own the “full-size” Pickup truck revenue, and more importantly, profitability in the full-size space. For 2019 GMC released a new line of trucks with a built in step-ladder tailgate. This makes access to the bed of the truck easier. However, a step ladder is still tedious to use and could cause lower back injuries when moving large or heavy items into the truck bed such as a refrigerator or mulch/gravel/pavers.

The solution as currently available on the market offers only two options: 1) The user purchases a folding aircraft aluminum ramp. The ramp props up on the lowered tailgate. These ramps are death traps. Go to YouTube and search truck ramp fails or 4wheeler ramp fails. These ramps do not securely attach to the back of the tailgate. Thus, the ramp can easily fall off the tailgate during use.

In addition, these ramps do not have guard rails, meaning that if a wheel was to go over the side of the ramp an accident will occur. Finally, they take up space in the tailgate and there is no good way to store them during travel. Many people believe these ramps are so dangerous that they purchase a small trailer to pull a 4wheeler, etc. which renders the truck bed moot. 2) The user purchases an after-market tailgate which has a ramp built-in to it. This requires the user to dispose of the tailgate that matches the truck. After spending $40-70k on a truck, a buyer wants the tailgate to match their truck. These aftermarket tailgates are ugly. They look like a metal cage contraption that sits on the back of the truck permanently. In addition, they are not easy to deploy and are heavy and require multiple horizontal folds to deploy and store. Ford has sold a truck with a ramp system as an add-on.

A YouTube video of a guy showing it off can be found online. This system is two “track” rails that are mounted to both sides of the tailgate when stored (ugly and take up space). In order to deploy, the user must unscrew both rails at 2 different points each (front and back) from the stored position (which is a royal pain). This allows rail ramps to be removed from the back of the truck. The user then slides the rails onto a tongue and groove on the back of the lowered tailgate. The user must then move both rails to align perfectly with the wheels of say a 4wheeler, prior to attempting to get it up the rails and into the bed.

Because there is no guard rail, if a tire slips off one of these slender track rails, an accident will occur. Once complete, the user must remove both track rails and re-install them on both sides of the truck bed and reattach the wingnut screws. A cool add, but not very useful, because it is dangerous and difficult/time consuming to deploy. In addition, a dolly or wheelbarrow could not be used with these track rails as they are too slender (a little more than the width of a 4wheeler tire).

### SUMMARY OF THE DISCLOSURE

An extendable truck bed ramp is housed adjacent the bed of the truck and tailgate when the tailgate is lowered and open. The ramp deploys using a track system inside the bed of the truck and the tailgate respectively. The ramp contains side rails for easy access with items such as hand trucks, ATVs, and other wheeled items. The method for joining a truck bed with a loading surface includes attaching at least two parallel tracks to a floor of a truck bed and to a floor side of a tailgate configured to form continuous tracks based on a foldout of the tailgate, permanently embedding into the at least two parallel tracks each, at least two complementary sliders and moving the truck ramp with folding side rails into a joining position between the truck bed and the loading surface via the at least four sliders attached there beneath.

### BRIEF DESCRIPTION OF DRAWINGS

FIG. 1 depicts the attached foldable full bed ramp deployed from the truck in accordance with an embodiment of the present disclosure.

FIG. 2 is a flow chart of a method of deploying a truck ramp from the floor of a truck bed in accordance with an embodiment of the present disclosure.

### DETAILED DESCRIPTION

The present invention is an extendable truck bed ramp, built into the truck during manufacturing.

The present disclosure is simple to deploy, not visible when not in use, secure and has guard rails built into the ramp for safety. It would be as effortless as possible to deploy for the user (hit a button and it deploys or stores itself).

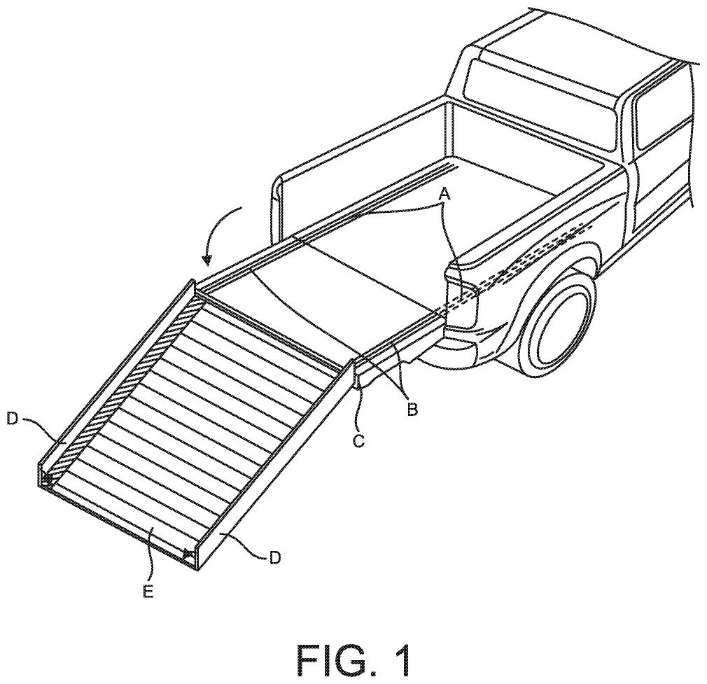

FIG. 1 depicts a truck ramp extended from the truck bed in accordance with an embodiment of the present disclosure. The ramp rolls out from a track system riveted to the bed of the truck underneath the truck bed liner and on a track system embedded in the tailgate. Neither track system can be seen or detected when not in use as it is housed inside the bed and tailgate respectively. Additionally, the tailgate has a door or hatch from which the deployed ramp extends or which can be closed when ramp is not in use. The extended ramp contains foldable guard rails that may be extended up to prevent items from rolling or falling off the sides of the ramp when in use.

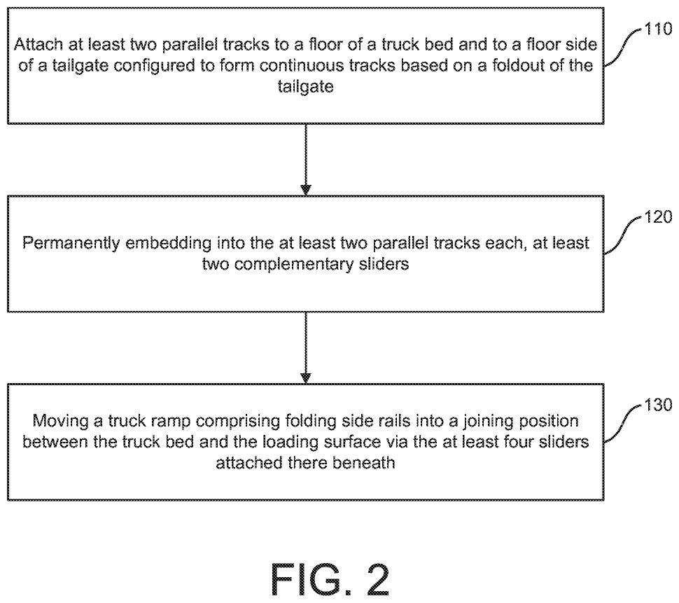

FIG. 2 is a flow chart of a method of deploying a truck ramp from the floor of a truck bed in accordance with an embodiment of the present disclosure. The method for joining a truck bed with a loading surface includes attaching at least two parallel tracks to a floor of a truck bed and to a floor side of a tailgate configured to form continuous tracks based on a foldout of the tailgate. The method also includes permanently embedding into the at least two parallel tracks each, at least two complementary sliders. The method additionally includes moving a truck ramp comprising folding side rails into a joining position between the truck bed and the loading surface via the at least four sliders attached there beneath.

foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A truck ramp system comprising:
a. at least two parallel tracks attached to a floor of a truck bed and to a floor side of a tailgate configured to form continuous tracks based on a foldout of the tailgate;
b. a truck ramp comprising folding side rails and a catch at one end to prevent a separation of the truck ramp from the at least two tracks; and
c. at least four sliders complementary to and held in the at least two tracks and permanently attached to an underside of the truck ramp.

2. The truck ramp of claim 1, wherein the at least two tracks are an after-market product attached to the floor of the truck bed and to the floor side of the tailgate after the truck is manufactured.

3. The truck ramp of claim 1, wherein the at least two parallel tracks are permanently attached to the floor of the truck bed and to the floor side of the tailgate via one of steel rivets and a steel weld and other permanent fasteners.

4. The truck ramp of claim 1, further comprising folding portions of the at least two tracks, the folding portions configured part of the continuous tracks despite a foldup of the tailgate to the truck bed.

5. The truck ramp of claim 1, wherein the at least four sliders are wheels irremovably embedded into the at least two parallel tracks, two wheels per each of the at least two tracks.

6. The truck ramp of claim 1, wherein the catch comprises a metal lip configured to catch a complementary lip at an edge of a free long edge of the tailgate.

7. The truck ramp of claim 1, wherein the folding side rails are configured to lay flat against a floor side of the truck ramp and to snap into place at ninety degrees to the truck ramp floor.

8. The truck ramp of claim 1, wherein the truck ramp rolls, glides and slides within the at least two tracks via the at least 4 sliders and is always engaged there with.

9. The truck ramp of claim 1, wherein the truck ramp is stowed above and immediately adjacent the floor of the truck bed.

10. The truck ramp of claim 1, wherein a length of the truck ramp is less than or equal to a length of the truck bed.

11. A method for joining a truck bed with a loading surface, comprising:
a. attaching at least two parallel tracks to a floor of a truck bed and to a floor side of a tailgate configured to form continuous tracks based on a foldout of the tailgate;
b. permanently embedding into the at least two parallel tracks each, at least two complementary sliders;
c. moving a truck ramp comprising folding side rails into a joining position between the truck bed and the loading surface via the at least four sliders attached there beneath.

12. The truck ramp of claim 11, further comprising attaching at least two after-market tracks to the floor of the truck bed and to the floor side of the tailgate after the truck is manufactured.

13. The truck ramp of claim 1, further comprising attaching the at least two parallel tracks permanently to the floor of the truck bed and to the floor side of the tailgate via one of steel rivets and a steel weld and other permanent fasteners.

14. The truck ramp of claim 1, further comprising folding portions of the at least two tracks, the folding portions configured part of the continuous tracks despite a foldup of the tailgate to the truck bed.

15. The truck ramp of claim 1, further comprising irremovably embedding the at least four sliders into the at least two parallel tracks, two wheels per each of the at least two tracks.

16. The truck ramp of claim 1, further comprising catching a complementary lip at an edge of a free long edge of the tailgate via a metal lip in the catch.

17. The truck ramp of claim 1, further comprising snapping into place the folding side rails from a flat position against a floor side of the truck ramp to a position ninety degrees to the truck ramp floor.

18. The truck ramp of claim 1, further comprising rolling, gliding and sliding the truck ramp within the at least two tracks via the at least 4 sliders always engaged there with.

19. The truck ramp of claim 1, further comprising stowing the truck ramp in-track above and immediately adjacent the floor of the truck bed.

20. The truck ramp of claim 1, further comprising limiting a length of the truck ramp to less than or equal to a length of the truck bed.
